(19) United States
(12) Patent Application Publication
(10) Pub. No.: US 2014/0112414 A1
(43) Pub. Date: Apr. 24, 2014

(54) POWER AMPLIFIER AND THE RELATED POWER AMPLIFYING METHOD

(71) Applicant: MediaTek Singapore Pte. Ltd., Singapore (SG)

(72) Inventors: Chao Lu, Fremont, CA (US); Sang Won Son, Palo Alto, CA (US)

(21) Appl. No.: 13/907,985

(22) Filed: Jun. 3, 2013

Related U.S. Application Data
(60) Provisional application No. 61/715,405, filed on Oct. 18, 2012.

(51) Int. Cl. H04L 27/36

(52) U.S. Cl. CPC H04L 27/368
USPC 375/297

(57) ABSTRACT

A power amplifier includes: a plurality of amplifying stages arranged to generate an output signal at an output terminal according to a phase-modulated signal and a plurality of amplitude-modulated signals, where each amplifying stage is arranged to receive the phase-modulated signal and one of the plurality of amplitude-modulated signals; an inductive circuit coupled between the output terminal and a first reference voltage; a matching circuit coupled between the output terminal and a loading circuit for providing a matching impedance between the output terminal and the loading circuit; and a capacitive circuit coupled to the output terminal for providing an adjustable capacitance to adjust a loading capacitance at the output terminal according to an adjusting signal; wherein the adjusting signal is indicative of a power of the output signal.

### CROSS REFERENCE TO RELATED APPLICATIONS

This application claims the benefit of U.S. Provisional Application No. 61/715,405, which was filed on Oct. 18, 2012, and is included herein by reference.

### BACKGROUND

The present invention relates to a power amplifier and a related power amplifying method, and more particularly to a digital power amplifier and a related power amplifying method.

Use of digital power amplifiers (DPAs) is desirable in some transmitters within wireless communication systems because the advanced complementary metal-oxide-semiconductor (CMOS) technology enables fast switching speed for the DPAs. Conventionally, one DPA comprises a CORDIC (Coordinate Rotation Digital Computer) and a digital polar transmitter, wherein the CORDIC is used to convert a digital in-phase signal (I) and a digital quadrature signal (Q) into a digital phase modulation (PM) signal and a digital amplitude modulation (AM) signal, and the digital polar transmitter is used to output an amplified RF (Radio Frequency) signal according to the digital PM signal and the digital AM signal. The digital polar transmitter comprises a decoder and a plurality of unit power cells, wherein the plurality of unit power cells receive the digital PM signal, and the decoder decodes the digital AM signal to selectively turn on an appropriate number of unit power cells. In other words, the digital AM signal acts as a control codeword to control the power of the amplified RF signal. In the back-off operation (e.g. the large or full power of the amplified RF signal) of the DPA, however, the power efficiency and the signal linearity of the DPA are greatly degraded due to the code-dependent output capacitance of the digital polar transmitter. For example, the output capacitance of the digital polar transmitter becomes large when the power of the amplified RF signal is large, or vice versa. Therefore, there is a need for an innovative DPA design to deal with the code-dependent output capacitance of the digital polar transmitter for improving power efficiency and signal linearity.

### SUMMARY

One objective of the present invention is to provide a digital power amplifier having good power efficiency and signal linearity, and a related amplifying method.

According to a first embodiment, a power amplifier is disclosed. The power amplifier comprises a plurality of amplifying stages, an inductive circuit, a matching circuit, and a capacitive circuit. The plurality of amplifying stages are arranged to generate an output signal at an output terminal according to a phase-modulated signal and a plurality of amplitude-modulated signals, and each amplifying stage is arranged to receive the phase-modulated signal and one of the plurality of amplitude-modulated signals. The inductive circuit is coupled between the output terminal and a first reference voltage. The matching circuit is coupled between the output terminal and a loading circuit for providing a matching impedance between the output terminal and the loading circuit. The capacitive circuit is coupled to the output terminal for providing an adjustable capacitance to adjust a loading capacitance at the output terminal according to an adjusting signal, wherein the adjusting signal is indicative of a power of the output signal.

According to a second embodiment, a power amplifying method is disclosed. The power amplifying method comprises: providing a plurality of amplifying stages to generate an output signal at an output terminal according to a phase-modulated signal and a plurality of amplitude-modulated signals, wherein each amplifying stage is arranged to receive the phase-modulated signal and one of the plurality of amplitude-modulated signals; providing an inductive circuit to couple between the output terminal and a first reference voltage; providing a matching circuit to provide a matching impedance between the output terminal and a loading circuit; and providing a capacitive circuit having an adjustable capacitance to adjust a loading capacitance at the output terminal according to an adjusting signal; wherein the adjusting signal is indicative of a power of the output signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an ideal drain efficiency of a digital power amplifier.

FIG. 2 is a diagram illustrating a digital power amplifier according to a first embodiment of the present invention.

FIG. 3 is a diagram illustrating a single amplifying stage in a plurality of amplifying stages according to an embodiment of the present invention.

FIG. 4 is a diagram illustrating a half-circuit of an amplifying stage according to an embodiment of the present invention.

FIG. 5 is a diagram illustrating a simplified circuit of a half-circuit according to an embodiment of the present invention.

FIG. 6 is a timing diagram illustrating an output voltage and an output current at an output terminal if the capacitive circuit and the controlling circuit are absent in the digital power amplifier during the power back-off state.

FIG. 7 is a diagram illustrating the relationship between the AM codeword corresponding to a plurality of amplitude-modulated signals and a capacitance of the capacitive circuit according to an embodiment of the present invention.

FIG. 8 is a timing diagram illustrating an output voltage and an output current at the output terminal if the capacitive circuit and the controlling circuit are present in the digital power amplifier during the power back-off state.

FIG. 9 is a diagram illustrating a digital power amplifier according to a second embodiment of the present invention.

FIG. 10 is a diagram illustrating a digital power amplifier according to a third embodiment of the present invention.

FIG. 11 is a diagram illustrating a digital power amplifier according to a fourth embodiment of the present invention.

FIG. 12 is a diagram illustrating a capacitive circuit according to a first embodiment of the present invention.

FIG. 13 is a diagram illustrating a capacitive circuit according to a second embodiment of the present invention.

FIG. 14 is a diagram illustrating a capacitive circuit according to a third embodiment of the present invention.

FIG. 15 is a flowchart illustrating a power amplifying method according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

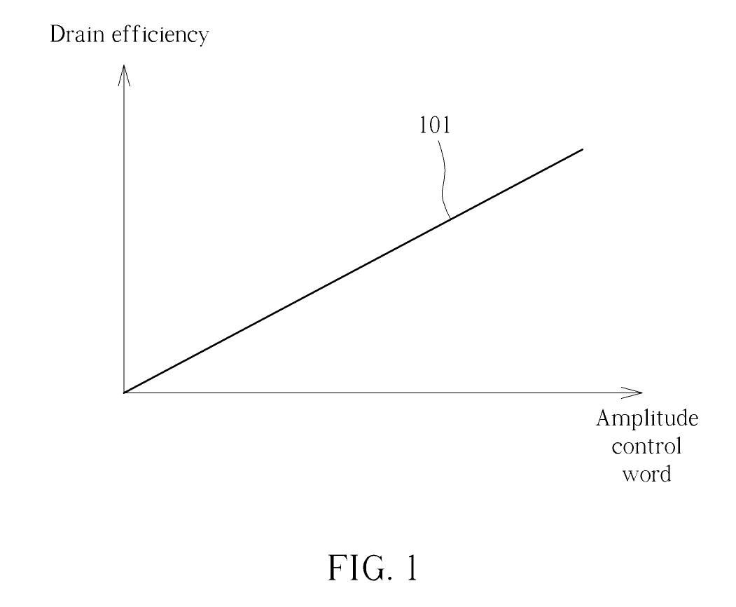

Please refer to FIG. 1, which is a diagram illustrating an ideal drain efficiency of a digital power amplifier (DPA), in which the curve 101 is the drain efficiency corresponding to the amplitude, the X-axis plots the amplitude control word (i.e. output power), and the Y-axis plots the drain efficiency. Thus, the ideal DPA offers linear drain efficiency back-off with fixed power supply and load impedance. It is noted that when the DPA operates under the back-off operation, the DPA may generate the maximum or comparably large power of output signal. Practically, in order to have high initial power efficiency, the DPA is designed to have maximum efficiency at saturation power (Pₛₐₜ), i.e. to maximize η₀, wherein η₀ is the drain efficiency of when the DPA generates the output signal with the saturation power Pₛₐₜ.

$${P}_{sat} = {( {N}_{max} \cdot {I}_{0} )}^{2} {R}_{L} \\ {P}_{D C , sat} = {N}_{max} \cdot {I}_{D C 0 } \cdot {V}_{sup} = \frac{1}{{η}_{0}} {P}_{sat} \\ {P}_{L} = {( N \cdot {I}_{0} )}^{2} {R}_{L} = \frac{{N}^{2}}{{N}_{max}^{2}} {P}_{sat} \\ {P}_{D C} = N \cdot {I}_{D C 0} \cdot {V}_{sup} = \frac{N}{{N}_{max}} {P}_{D C , sat} = \frac{N}{{N}_{max}} \frac{1}{{η}_{0}} {P}_{sat} \\ η = \frac{{P}_{L}}{{P}_{D C}} = \frac{\frac{{N}^{2}}{{N}_{max}^{2}} {P}_{sat}}{\frac{N}{{N}_{max}} \frac{1}{{η}_{0}} {P}_{sat}} = \frac{N}{{N}_{max}} {η}_{0} \qquad ( 1 )$$

where Nₘₐₓ represents the total number of unit power cells in the DPA, I₀ represents the supply current flowing to each unit power cell, R_{L} represents the load impedance of the DPA, P_{DC,sat} represents the DC power consumed by the DPA when all the unit power cells are turned on, I_{DC0} represents the DC current of each unit power cell, Vₛᵤₚ represents the supply voltage of each unit power cell, N represents the number of turn-on unit power cells in the DPA, P_{DC} represents the DC power consumed by the DPA when N number of unit power cells are turned on in the DPA, and η represents the drain efficiency of the DPA when N number of unit power cells are turned on.

Therefore, according to the above equation (1), the drain efficiency η of the DPA is a straight line having a fixed slope (i.e. the curve 101 in FIG. 1). The number (i.e. N) of turn-on unit power cells in the DPA are controlled by the amplitude control word, and the number (i.e. N) of turn-on unit power cells correspond to the amplitude of the output signal. Ideally, when all the unit power cells are turned on, meaning that the power of the output signal is the saturation power Pₛₐₜ, the drain efficiency η of the DPA is the maximum drain efficiency, i.e. η₀.

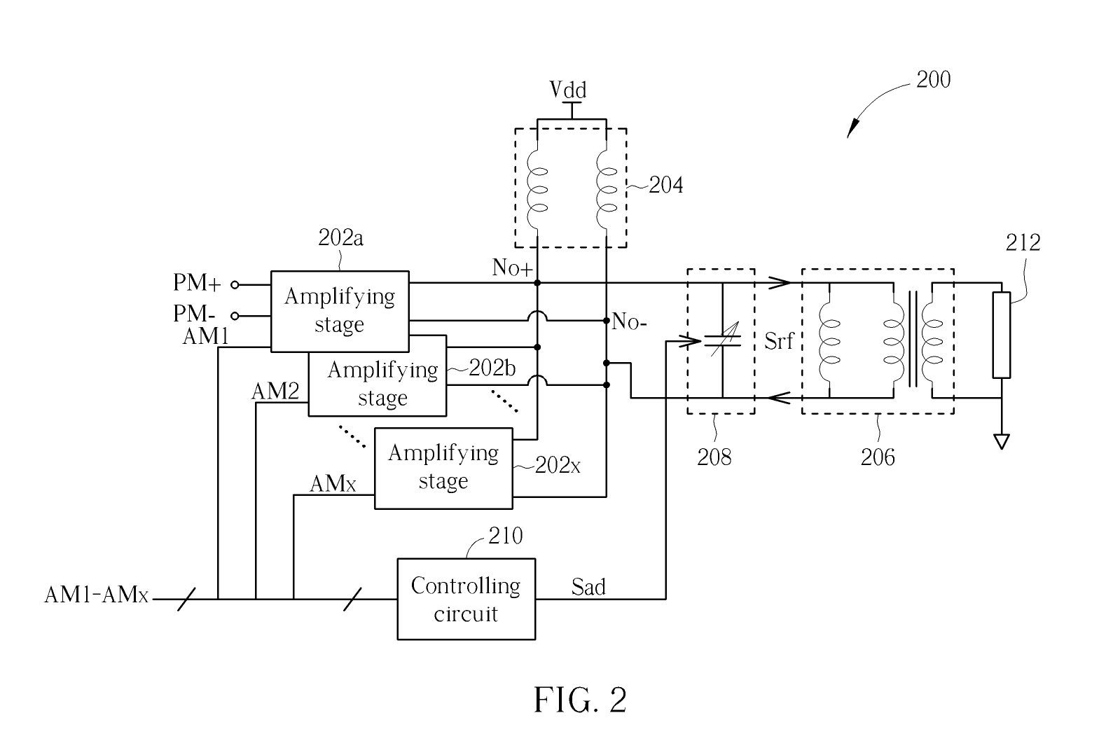

In practice, however, the non-ideality of the unit power cells may degrade the drain efficiency η of the DPA when the power of the output signal increases. Thus, the practical drain efficiency η of the DPA may no longer be as straight as the curve 101. Please refer to FIG. 2, which is a diagram illustrating a digital power amplifier 200 according to a first embodiment of the present invention. The digital power amplifier 200 comprises a plurality of amplifying stages 202a-202x, an inductive circuit 204, a matching circuit 206, a capacitive circuit 208, and a controlling circuit 210. A loading circuit 212 is also shown in FIG. 2 for descriptive purposes, and the loading circuit 212 is coupled to the matching circuit 206.

It is noted that digital power amplifier 200 is a differential circuit, but this is not a limitation of the present invention. One of ordinary skill in the art should understand that the single-end digital power amplifier also belongs to the scope of the present invention. The plurality of amplifying stages 202a-202x are arranged to generate the output signal Srf at an output terminal according to a phase-modulated signal PM+, PM−, and a plurality of amplitude-modulated signals AM1-AMx, and each amplifying stage is arranged to receive the phase-modulated signal PM+, PM− and one of the plurality of amplitude-modulated signals AM1-AMx. In this embodiment, the phase-modulated signal PM+, PM− and the plurality of amplitude-modulated signals AM1-AMx are digital signals, and the number of the plurality of amplitude-modulated signals AM1-AMx are the same as the number of the plurality of amplifying stages 202a-202x. This is not a limitation of the present invention, however. The inductive circuit 204 is coupled between the output terminal No+, No−, and a first reference voltage, i.e. the supply voltage Vdd. The inductive circuit 204 may be an RF choke of the digital power amplifier 200. The matching circuit 206 is coupled between the output terminal No+, No−, and the loading circuit 212 for providing a matching impedance between the output terminal No+, No−, and the loading circuit 206. The capacitive circuit 208 is a programmable capacitor, and the capacitive circuit 208 is coupled to the output terminal No+, No−, for providing an adjustable capacitance to adjust a loading capacitance at the output terminal No+, No−, according to an adjusting signal Sad, wherein the adjusting signal Sad is indicative of the power of the output signal Srf. The controlling circuit 210 is arranged to generate the adjusting signal Sad according to at least one amplitude-modulated signal of the plurality of amplitude-modulated signals AM1-AMx.

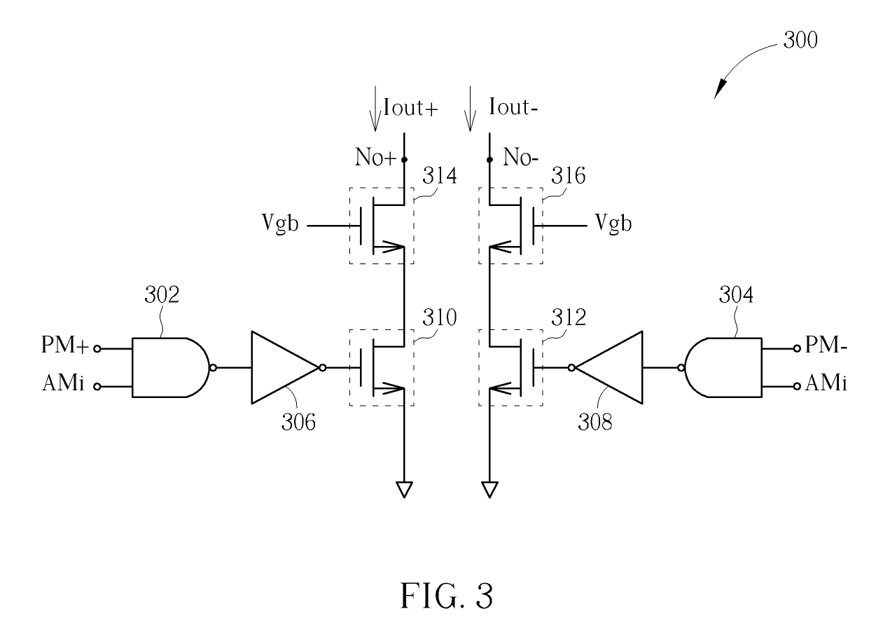

Please refer to FIG. 3, which is a diagram illustrating a single amplifying stage 300 in the plurality of amplifying stages 202a-202x according to an embodiment of the present invention. The amplifying stage 300 is a differential circuit stage. The amplifying stage 300 comprises a first NAND gate 302, a second NAND gate 304, a first inverter 306, a second inverter 308, a first N-type field-effected transistor (FET) 310, a second N-type FET 312, a third N-type FET 314, and a fourth N-type FET 316. The first NAND gate 302 is arranged to receive the positive signal PM+ in the phase-modulated signal PM+, PM−, and one of the amplitude-modulated signal (e.g. AMi) in the plurality of amplitude-modulated signals AM1-AMx. The second NAND gate 304 is arranged to receive the negative signal PM− in the phase-modulated signal PM+, PM−, and the same amplitude-modulated signal (i.e. AMi) inputting to the first NAND gate 302. The gates of the third N-type FET 314 and the fourth N-type FET 316 are coupled to a reference voltage Vgb for biasing the third N-type FET 314 and the fourth N-type FET 316. The drains of the third N-type FET 314 and the fourth N-type FET 316 are connected to the output terminal No+, No− respectively. It is noted that the detailed connectivity of the amplifying stage 300 is shown in FIG. 3, and the detailed description is omitted here for brevity. The amplifying stage 300 may be a current mode class-D power amplifier, but this is not a limitation of the present invention. The amplifying stage 300 may also be a class-E or an inverse class-F power amplifier. During the operation of the amplifying stage 300a, a first output current Iout+ flows through the left half circuit stage, and a second output current Iout− flows through the right half circuit stage, in which the first output current Iout+ and the second output current Iout− are differential signals.

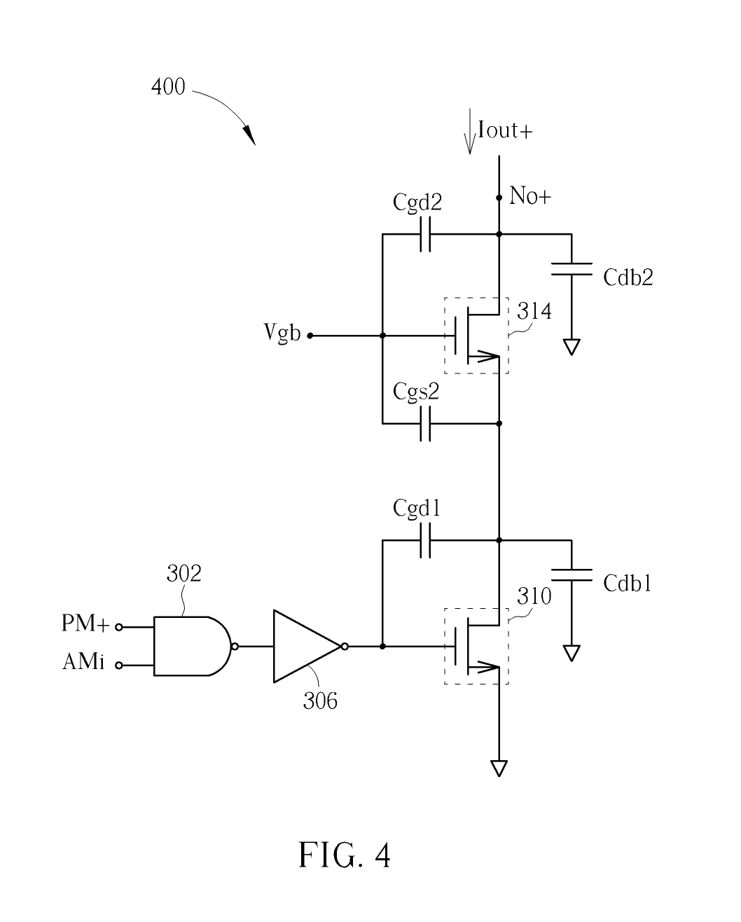

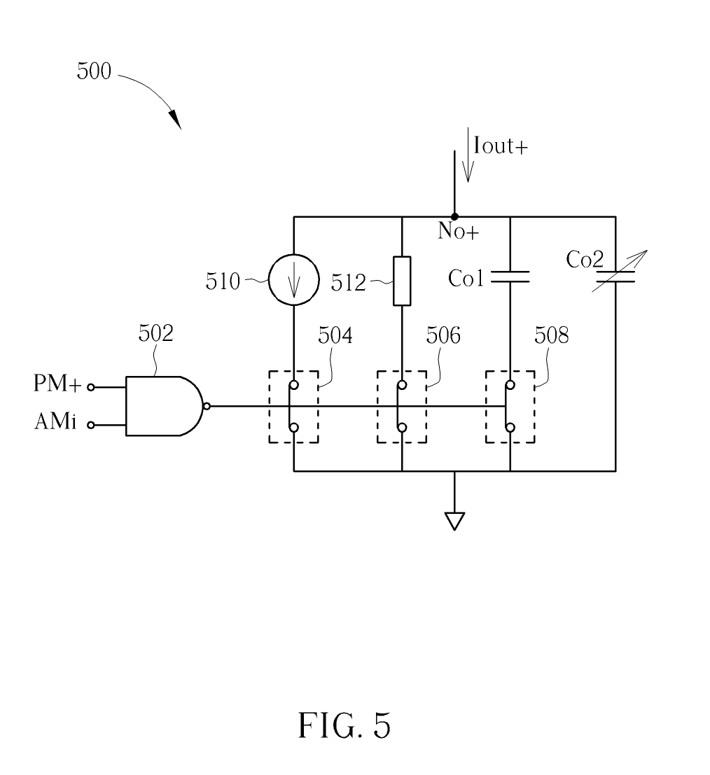

Please refer to FIG. 4, which is a diagram illustrating a half-circuit 400 of the amplifying stage 300 according to an embodiment of the present invention. For descriptive purposes, the half-circuit 400 only illustrates the positive half-circuit of the amplifying stage 300. One of ordinary skill in the art should understand that the negative half-circuit of the amplifying stage 300 also has similar characteristics. When the half-circuit 400 is turned on, at least five parasitic capacitors Cgd1, Cgd2, Cdb1, Cdb2, Cgs2 emerge from the first N-type FET 310 and the third N-type FET 314, wherein the capacitor Cgd1 is the parasitic capacitor between the gate and the drain of the first N-type FET 310, the capacitor Cgd2 is the parasitic capacitor between the gate and the drain (i.e. No+) of the second N-type FET 314, the capacitor Cdb1 is the parasitic capacitor between the drain and the substrate of the first N-type FET 310, the capacitor Cdb2 is the parasitic capacitor between the drain and the substrate of the second N-type FET 314, and the capacitor Cgs2 is the parasitic capacitor between the gate and the source of the second N-type FET 314. The capacitances of parasitic capacitors Cgd1, Cdb1, Cgd2, and Cgs2 are code-dependent, and the capacitances of parasitic capacitors Cdb1, Cdb2, Cgd2, and Cgs2 are power-dependent. More specifically, the code-dependent capacitance means the capacitance is affected by the input code (i.e. the positive signal PM+ and the amplitude-modulated signal AMi) of the half-circuit 400, and the power-dependent capacitance means the capacitance is affected by the power of output signal at the output terminal No+. For simplicity, the code-dependent effective output capacitors Cgd1, Cdb1, Cgd2, Cgs2 are represented by the capacitor Co1, and the power-dependent effective output capacitors Cdb1, Cdb2, Cgd2, Cgs2 are represented by the capacitor Co2 as shown in FIG. 5. FIG. 5 is a diagram illustrating a simplified circuit 500 of the half-circuit 400 according to an embodiment of the present invention. The simplified circuit 500 comprises a NAND gate 502, three switches 504, 506, 508, a variable current source 510, an output resistor 512, the capacitor Co1, and the capacitor Co2. It can be seen that the switches 504, 506, 508, the variable current source 510, the output resistor 512, and the capacitor Co1 are controlled by the positive signal PM+ and the amplitude-modulated signal AMi. The capacitor Co2 is a variable capacitor that is affected by the power of output signal at the output terminal No+. It should be noted that, in general, the output capacitance at the output terminal No+ of the half-circuit 400 can also be viewed as code-dependent because the output power at the output terminal No+ is a function of the input code, i.e. the phase-modulated signal PM+, PM−, and the plurality of amplitude-modulated signals AM1-AMx.

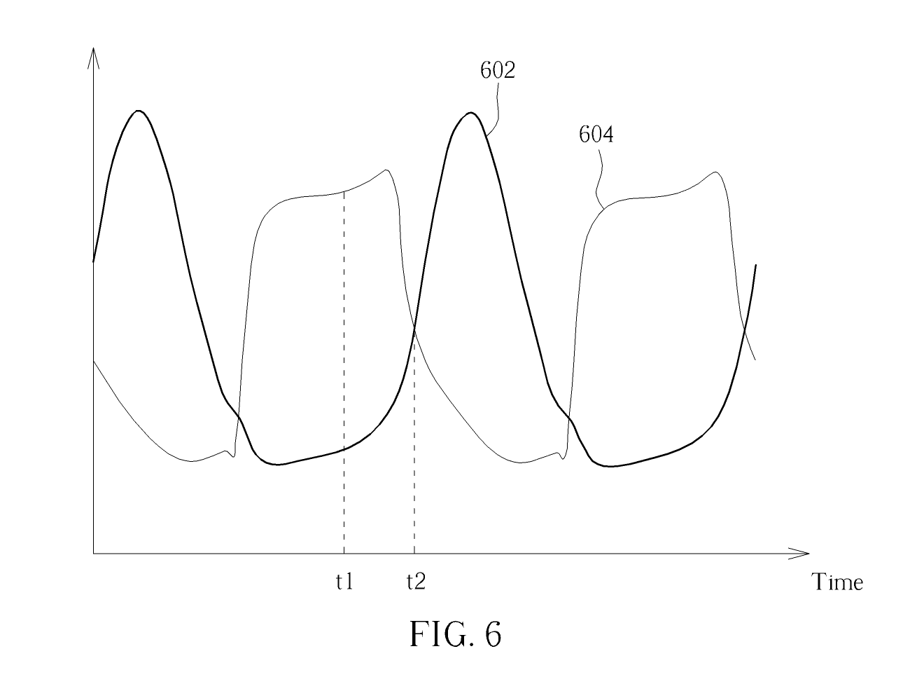

Accordingly, if all the amplifying stages 202a-202x are connected to the output terminal No+, No−, the effective capacitance at the output terminal No+, No− may vary greatly according to the input code, i.e. the phase-modulated signal PM+, PM−, and the plurality of amplitude-modulated signals AM1-AMx, if the present capacitive circuit 208 and the controlling circuit 210 are absent in the digital power amplifier 200. In other words, the linearity and the efficiency of the digital power amplifier 200 may be greatly reduced by the effective capacitance at the output terminal No+, No− if the present capacitive circuit 208 and the controlling circuit 210 are absent in the digital power amplifier 200. Please refer to FIG. 6, which is a timing diagram illustrating an output voltage Vout and an output current Iout at the output terminal No+ (or No−) if the capacitive circuit 208 and the controlling circuit 210 are absent in the digital power amplifier 200 during the power back-off state. The output voltage Vout is represented by curve 602, and the output current Iout is represented by curve 604. The output voltage Vout and the output current Iout are in response to the phase-modulated signal PM+, PM−, and the plurality of amplitude-modulated signals AM1-AMx. It can be seen that, in time interval t1-t2, the output current Iout is conducted and the output voltage Vout is non-zero. In other words, the overlapping between the output voltage Vout and the output current Iout happens in the time interval t1-t2. Therefore, the relation between the output voltage Vout and the output current Iout is not the ideal zero-voltage-switching (ZVS) case, and this degrades power efficiency. In addition, the power dependent effective output capacitance may induce severe AM-PM distortion to the output signal Srf.

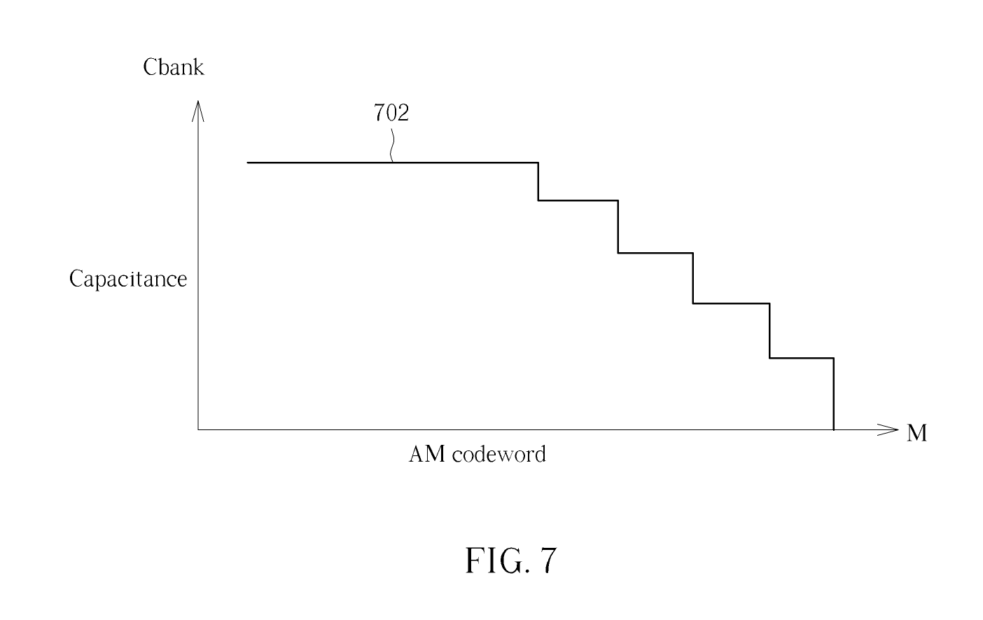

By using the capacitive circuit 208 and the controlling circuit 210, the present digital power amplifier 200 can substantially overcome the above mentioned problem. Please refer to FIG. 2 and FIG. 7, in which FIG. 7 is a diagram illustrating the relationship between the AM codeword M corresponding to the plurality of amplitude-modulated signals AM1-AMx and the capacitance Cbank of the capacitive circuit 208 according to an embodiment of the present invention. According to the arrangement of the capacitive circuit 208 and the controlling circuit 210, the controlling circuit 210 is arranged to receive the plurality of amplitude-modulated signals AM1-AMx and to control the capacitance Cbank of the capacitive circuit 208 according to the relationship as shown in FIG. 7. More specifically, according to the description in the above paragraphs, the total output capacitance contributed by the plurality of amplifying stages 202a-202x is dependent on the turn-on number of the plurality of amplifying stages 202a-202x, wherein the more amplifying stages in the plurality of amplifying stages 202a-202x that are turned on, the larger the output capacitance at the output terminal No+, No−. Therefore, to compensate for the effective output capacitance at the output terminal No+, No−, the controlling circuit 210 is arranged to adjust the capacitance Cbank of the capacitive circuit 208 to be inversely proportional to the amplitude (or power) of the output signal Srf. It is noted that the amplitude (or power) of the output signal Srf of the digital power amplifier 200 is dependent on the plurality of amplitude-modulated signals AM1-AMx. Therefore, the adjusting signal Sad generated by the controlling circuit 210 is indicative of the power of the output signal Srf.

In FIG. 7, when the AM codeword M of the plurality of amplitude-modulated signals AM1-AMx represents a low output power, the controlling circuit 210 adjusts the capacitive circuit 208 to have large (or maximum) capacitance Cbank, and when the AM codeword M of the plurality of amplitude-modulated signals AM1-AMx represents a larger output power (e.g. power back-off), the controlling circuit 210 adjusts the capacitive circuit 208 to have small (or minimum) capacitance Cbank. Accordingly, the effective capacitance at the output terminal No+, No− can be kept intact no matter whether the power of the output signal Srf is large or small. In other words, the arrangement of the capacitive circuit 208 and the controlling circuit 210 is to reduce the output capacitance dependency on the power of the output signal Srf.

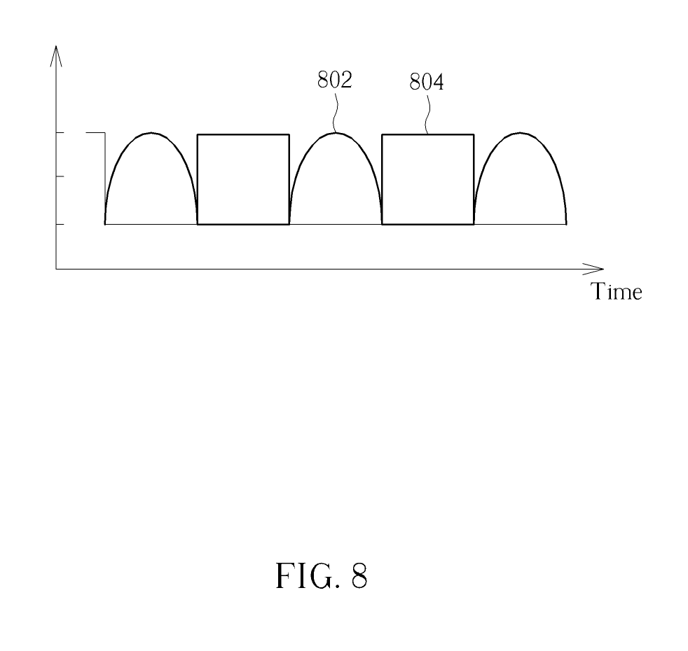

When the output capacitance dependency on the power of the output signal Srf is reduced, the AM-PM distortion of the output signal Srf can be improved. Moreover, the programmable capacitors (i.e. the capacitive circuit 208) also help in minimizing the overlapping between the output voltage Vout and the output current Iout at the output terminal No+, No− (e.g. approximating ZVS case), and thus improving the efficiency at the power back-off state. In addition, it is easy to integrate the programmable capacitors into the digital power amplifier 200 as a single chip. Please refer to FIG. 8, which is a timing diagram illustrating the output voltage Vout and the output current Iout at the output terminal No+ (or No−) if the capacitive circuit 208 and the controlling circuit 210 are present in the digital power amplifier 200 during the power back-off state. The output voltage Vout is represented by curve 802, and the output current Iout is represented by curve 804. It can be seen that there is minimal overlapping between the output voltage Vout and the output current Iout. Therefore, by using the capacitive circuit 208 and the controlling circuit 210, the linearity of the output signal Srf and the efficiency of the digital power amplifier 200 can be greatly improved.

It should be noted that the curve 702 in FIG. 7 is just an exemplary embodiment of the present invention. One skilled in the art should understand that any other embodiments having the characteristic of inverse proportion between the capacitance Cbank of the capacitive circuit 208 and the amplitude (or power) of the output signal Srf also belong to the scope of the present invention. Moreover, the controlling circuit 210 is not limited to using all the amplitude-modulated signals AM1-AMx to generate the adjusting signal Sad. Part of the amplitude-modulated signals AM1-AMx can also be used to generate the adjusting signal Sad.

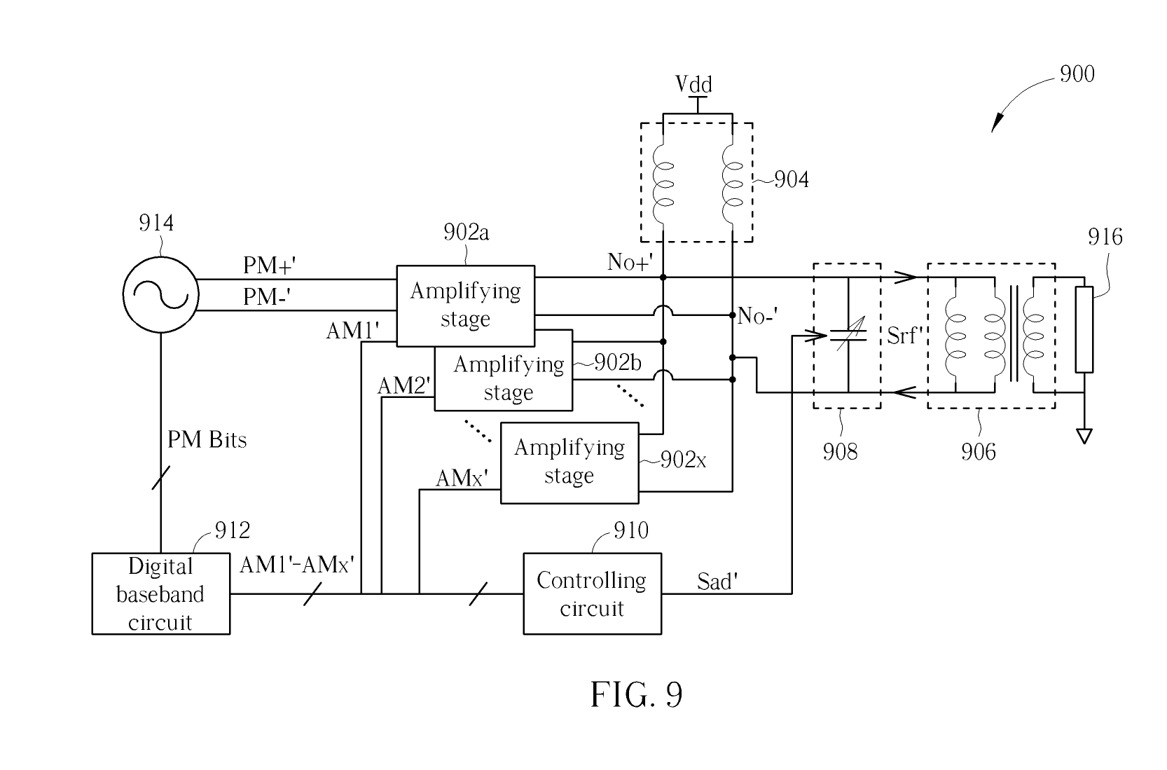

Please refer to FIG. 9, which is a diagram illustrating a digital power amplifier 900 according to a second embodiment of the present invention. The digital power amplifier 900 comprises a plurality of amplifying stages 902a-902x, an inductive circuit 904, a matching circuit 906, a capacitive circuit 908, a controlling circuit 910, a digital baseband circuit 912, and a digital controllable oscillator 914. A loading circuit 916 is also shown in FIG. 9, and the loading circuit 912 is coupled to the matching circuit 906. The plurality of amplifying stages 902a-902x are arranged to generate the output signal Srf′ at an output terminal according to a phase-modulated signal PM+′, PM−′, and a plurality of amplitude-modulated signals AM1′-AMx′, and each amplifying stage is arranged to receive the phase-modulated signal PM+′, PM−′ and one of the plurality of amplitude-modulated signals AM1′-AMx′. Compared to the first embodiment (i.e. the digital power amplifier 200), this embodiment is limited to using the digital controllable oscillator 914 to generate the phase-modulated signal PM+′, PM−′, and using digital baseband circuit 912 to generate the plurality of amplitude-modulated signals AM1′-AMx′, wherein the digital controllable oscillator 914 generates the phase-modulated signal PM+′, PM−′ according to phase-modulated (PM) bits generated by the digital baseband circuit 912. When the plurality of amplitude-modulated signals AM1′-AMx′ represent a low output power, the controlling circuit 910 adjusts the capacitive circuit 908 to have large (or maximum) capacitance, and when the plurality of amplitude-modulated signals AM1′-AMx′ represent a larger output power, the controlling circuit 910 adjusts the capacitive circuit 908 to have small (or minimum) capacitance. Accordingly, the effective capacitance at the output terminal No+′, No−′ can be kept intact no matter whether the power of the output signal Srf′ is large or small.

Similar to the first embodiment, the controlling circuit 910 is capable of using all or part of the amplitude-modulated signals AM1′-AMx′ to control the capacitance of the capacitive circuit 908. It is noted that the operation and the effect of the digital power amplifier 900 are similar to the digital power amplifier 200; the detailed description is therefore omitted here for brevity.

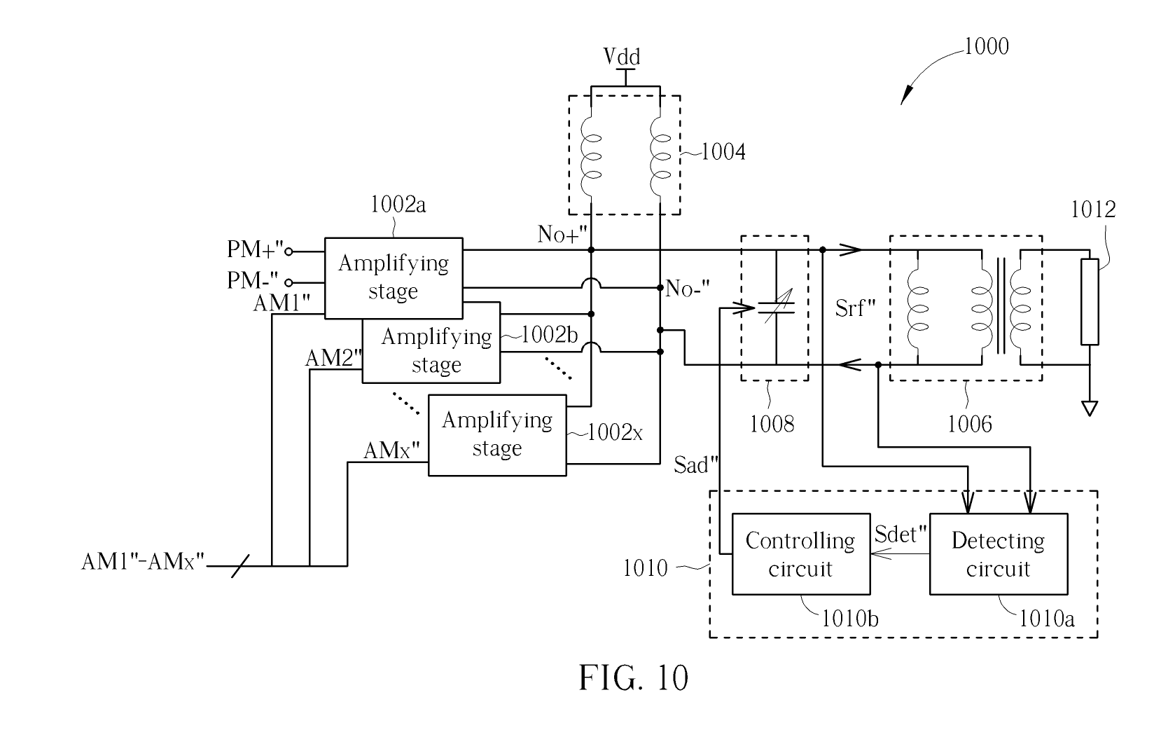

Please refer to FIG. 10, which is a diagram illustrating a digital power amplifier 1000 according to a third embodiment of the present invention. The digital power amplifier 1000 comprises a plurality of amplifying stages 1002a-1002x, an inductive circuit 1004, a matching circuit 1006, a capacitive circuit 1008, and a controlling circuit 1010. A loading circuit 1012 is also shown in FIG. 10, and the loading circuit 1012 is coupled to the matching circuit 1006. The plurality of amplifying stages 1002a-1002x are arranged to generate the output signal Srf″ at an output terminal according to a phase-modulated signal PM+″, PM−″, and a plurality of amplitude-modulated signals AM1″-AMx″, and each amplifying stage is arranged to receive the phase-modulated signal PM+″, PM−″ and one of the plurality of amplitude-modulated signals AM1″-AMx″. The controlling circuit 1010 comprises a detecting circuit 1010a and a controlling unit 1010b. The detecting circuit 1010a is arranged to detect the power of the output signal Srf″ for generating a detecting signal Sdet″. The controlling unit 1010b is arranged to generate the adjusting signal Sad″ according to the detecting signal Sdet″. The plurality of amplifying stages 1002a-1002x are arranged to generate the output signal Srf″ at an output terminal according to a phase-modulated signal PM+″, PM−″, and a plurality of amplitude-modulated signals AM1″-AMx″, and each amplifying stage is arranged to receive the phase-modulated signal PM+″, PM−″ and one of the plurality of amplitude-modulated signals AM1″-AMx″. Compared to the first embodiment (i.e. the digital power amplifier 200), this embodiment is limited to using the detecting circuit 1010a to detect the power of the output signal Srf″ for generating a detecting signal Sdet″, then the controlling unit 1010b adjusts the capacitance of the capacitive circuit 908 according to the detecting signal Sdet″. More specifically, when the power of the output signal Srf″ is lower, the controlling circuit 1010 adjusts the capacitive circuit 1008 to have larger capacitance, and when the power of the output signal Srf″ is higher, the controlling circuit 1010 adjusts the capacitive circuit 1008 to have smaller capacitance. Accordingly, the effective capacitance at the output terminal No+″, No−″ can be kept intact no matter whether the power of the output signal Srf″ is large or small.

It is noted that the operation and the effect of the digital power amplifier 1000 are similar to the digital power amplifier 200; the detailed description is therefore omitted here for brevity.

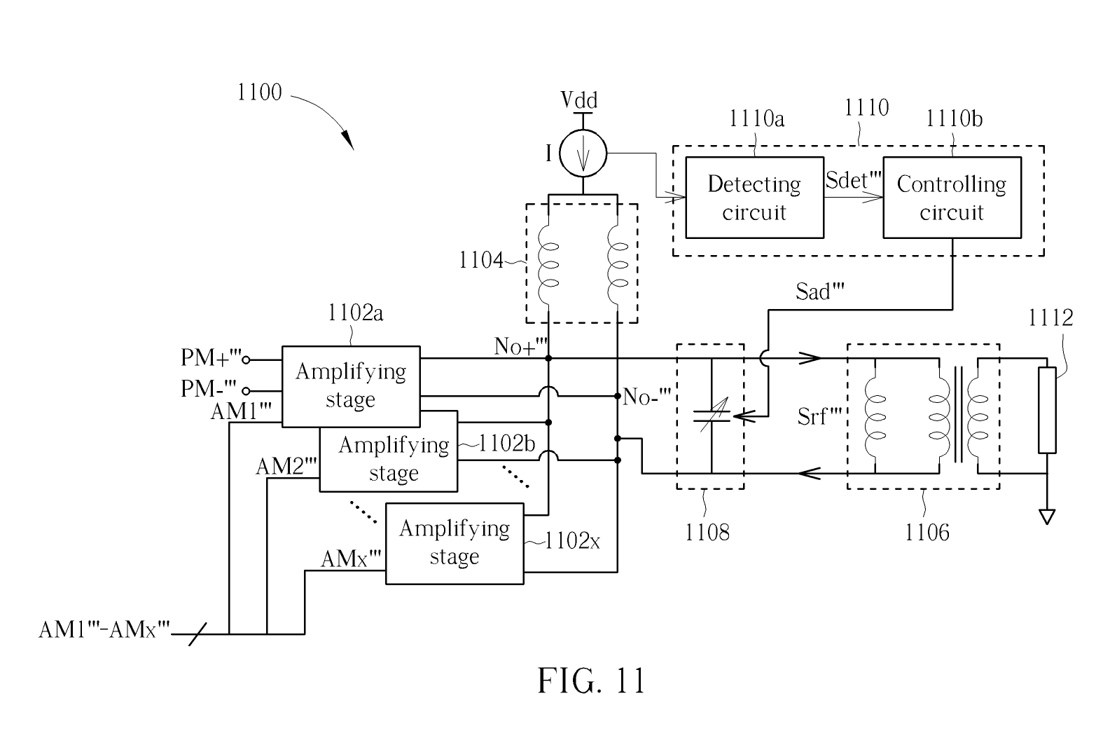

Please refer to FIG. 11, which is a diagram illustrating a digital power amplifier 1100 according to a fourth embodiment of the present invention. The digital power amplifier 1100 comprises a plurality of amplifying stages 1102a-1102x, an inductive circuit 1104, a matching circuit 1106, a capacitive circuit 1108, and a controlling circuit 1110. A loading circuit 1112 is also shown in FIG. 11, and the loading circuit 1112 is coupled to the matching circuit 1106. The plurality of amplifying stages 1102a-1102x are arranged to generate the output signal Srf′″ at an output terminal according to a phase-modulated signal PM+′″, PM−′″, and a plurality of amplitude-modulated signals AM1′″-AMx′″, and each amplifying stage is arranged to receive the phase-modulated signal PM+″′, PM−′″ and one of the plurality of amplitude-modulated signals AM1″′-AMx′″. The controlling circuit 1110 comprises a detecting circuit 1110a and a controlling unit 1110b. The detecting circuit 1110a is arranged to detect the current I flowing through the inductive circuit 1104 for generating a detecting signal Sdet′″. The controlling unit 1110b is arranged to generate the adjusting signal Sad′″ according to the detecting signal Sdet′″. The plurality of amplifying stages 1102a-1102x are arranged to generate the output signal Srf′″ at an output terminal according to a phase-modulated signal PM+′″, PM−′″, and a plurality of amplitude-modulated signals AM1′″-AMx′″, and each amplifying stage is arranged to receive the phase-modulated signal PM+′″, PM−′″ and one of the plurality of amplitude-modulated signals AM1′″-AMx′″. Compared to the first embodiment (i.e. the digital power amplifier 200), this embodiment is limited to using the detecting circuit 1110a to detect the supply current I of the inductive circuit 1104 for adjusting the capacitance of the capacitive circuit 1108. It is noted that the supply current I is proportional to the power of the output signal Srf′″. Therefore, when the current I is smaller, the controlling circuit 1110 adjusts the capacitive circuit 1108 to have larger capacitance, and when the current I is larger, the controlling circuit 1110 adjusts the capacitive circuit 1108 to have smaller capacitance. Accordingly, the effective capacitance at the output terminal No+′″, No−′″ can be kept intact no matter whether the power of the output signal Srf′″ is large or small.

It is noted that the operation and the effect of the digital power amplifier 1100 are similar to the digital power amplifier 200; the detailed description is therefore omitted here for brevity.

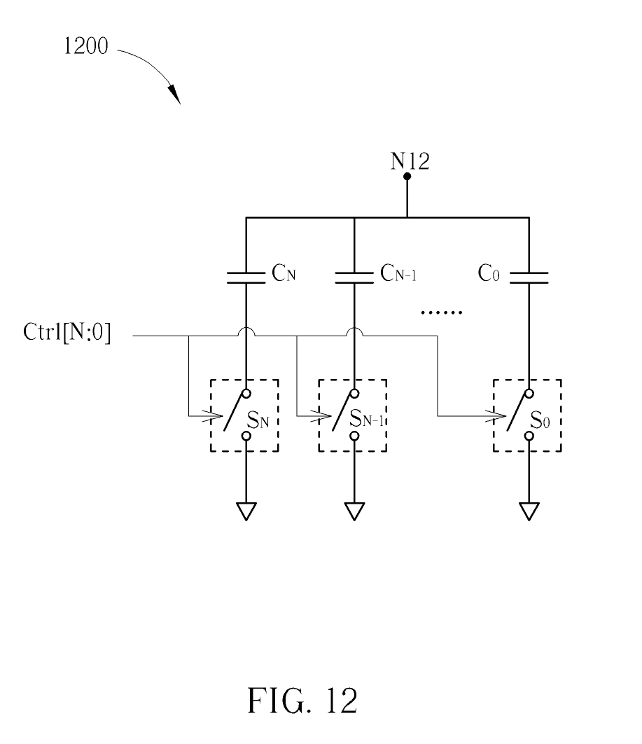

Please refer to FIG. 12, which is a diagram illustrating a capacitive circuit 1200 according to a first embodiment of the present invention. The capacitive circuit 1200 is a switched capacitor array comprising a plurality of capacitors C₀-C_{N} and a plurality of switches S₀-S_{N}. The plurality of switches S₀-S_{N} are controlled by the above mentioned adjusting signal Ctrl [N:0] (e.g. Sad), and the terminal N12 is coupled to the above-mentioned output terminal (e.g. No+ or No−). It is noted that, for descriptive purposes, the capacitive circuit 1200 illustrated in FIG. 12 is just a single-end version even though the capacitive circuits used in the above embodiments are differential circuits. Moreover, the adjusting signal Ctrl [N:0] is a digital signal, in which each bit in the digital signal is responsible for controlling one switch. Accordingly, by controlling the on/off between the switches S₀-S_{N}, the capacitance of the capacitive circuit 1200 can be adjusted.

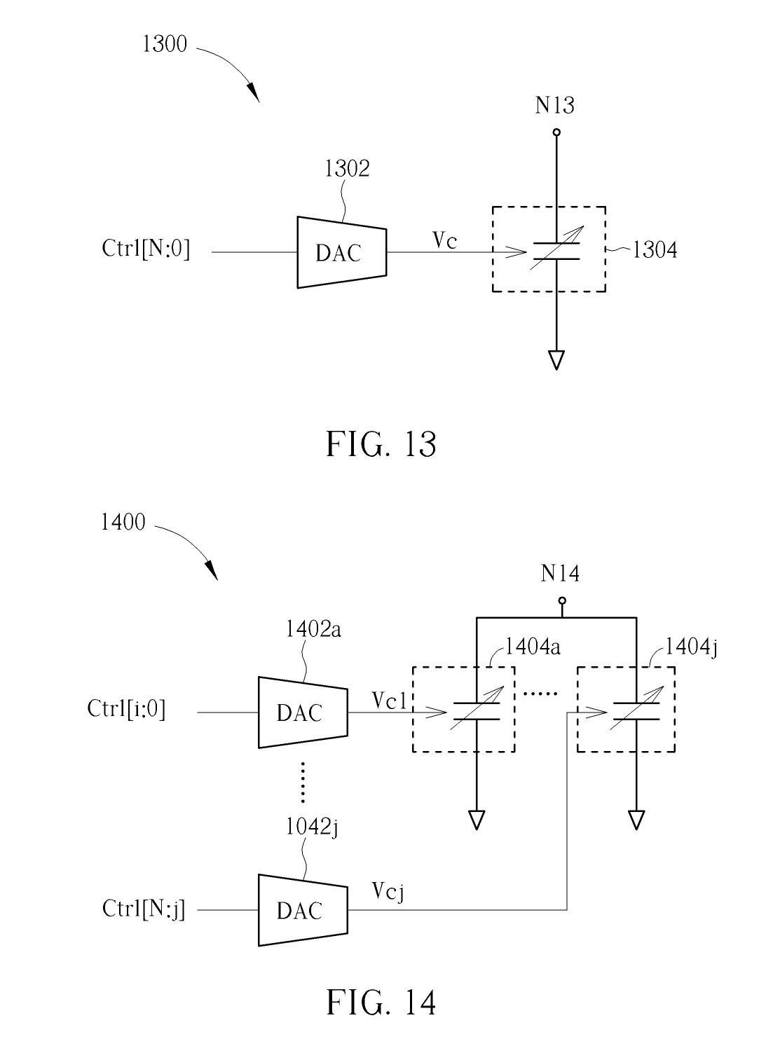

Please refer to FIG. 13, which is a diagram illustrating a capacitive circuit 1300 according to a second embodiment of the present invention. The capacitive circuit 1300 comprises a digital-to-analog converter (DAC) 1302 and a varactor 1304 (or a varactor array). The DAC 1302 receives the above mentioned adjusting signal Ctrl [N:0] (e.g. Sad) to generate a control signal Vc, and the control signal Vc controls the capacitance of the varactor 1304 accordingly. The terminal N13 is coupled to the above-mentioned output terminal (e.g. No+ or No−) . It is noted that, for descriptive purposes, the capacitive circuit 1300 illustrated in FIG. 13 is just a single-end version even though the capacitive circuits used in the above embodiments are differential circuits. Moreover, the adjusting signal is a digital signal.

Please refer to FIG. 14, which is a diagram illustrating a capacitive circuit 1400 according to a third embodiment of the present invention. The capacitive circuit 1400 comprises a plurality of digital-to-analog converters (DACs) 1402a-1402n and a plurality of varactors 1404a-1404n. The DACs 1402a-1402n receives the above mentioned adjusting signal Ctrl [i:0]-Ctrl [N:j] (e.g. Sad) to generate a plurality of control signals Vc1-Vcj respectively. Each control signal is responsible to control the capacitance of one varactor. The terminal N14 is coupled to the above-mentioned output terminal (e.g. No+ or No−). It is noted that, for descriptive purposes, the capacitive circuit 1400 illustrated in FIG. 14 is just a single-end version even though the capacitive circuits used in the above embodiments are differential circuits. Accordingly, by selectively controlling the capacitance of each varactor, the capacitance of the capacitive circuit 1400 can be adjusted.

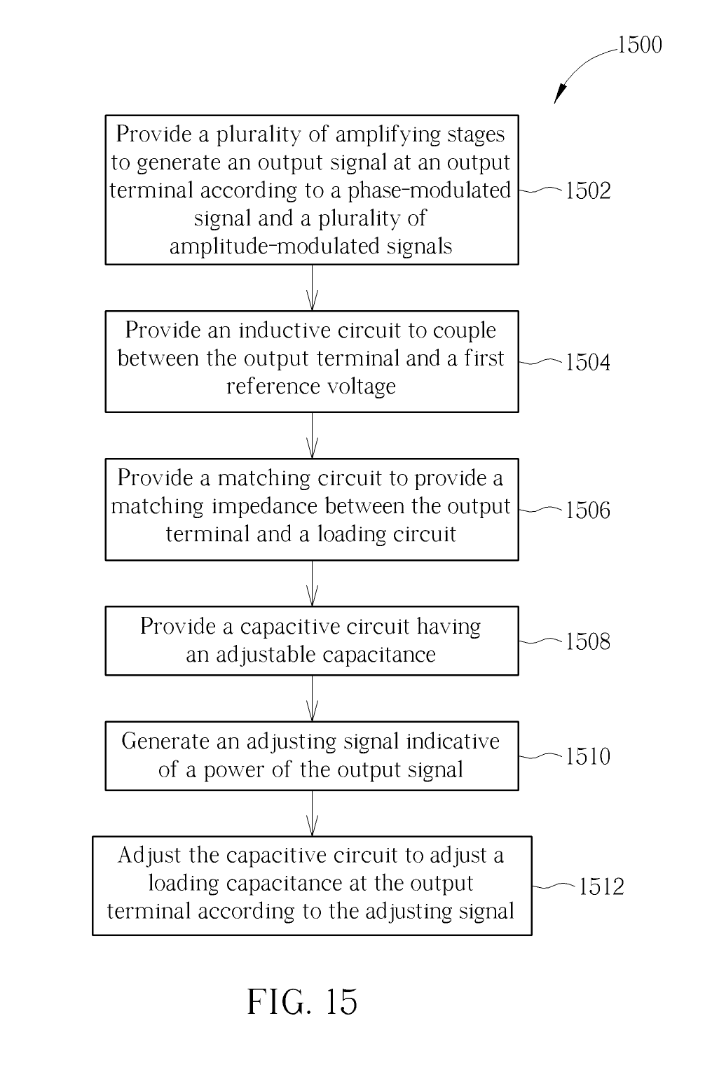

In summary, the operation of the above mentioned embodiments can be summarized into the following steps as shown in FIG. 15. FIG. 15 is a flowchart illustrating a power amplifying method 1500 according to an embodiment of the present invention. Provided that substantially the same result is achieved, the steps of the flowchart shown in FIG. 15 need not be in the exact order shown and need not be contiguous; that is, other steps can be intermediate. The power amplifying method 1500 comprises:

Step 1502: Provide a plurality of amplifying stages to generate an output signal at an output terminal according to a phase-modulated signal and a plurality of amplitude-modulated signals;

Step 1504: Provide an inductive circuit to couple between the output terminal and a first reference voltage;

Step 1506: Provide a matching circuit to provide a matching impedance between the output terminal and a loading circuit;

Step 1508: Provide a capacitive circuit having an adjustable capacitance;

Step 1510: Generate an adjusting signal indicative of a power of the output signal; and

Step 1512: Adjust the capacitive circuit to adjust a loading capacitance at the output terminal according to the adjusting signal.

Briefly, for a digital power amplifier, the loading capacitance at the output terminal is dependent on the on/off condition of the unit power cells . Then, by using the above-mentioned methods, the effective capacitance at the output terminal can be kept intact no matter whether the power of the output signal is large or small. Therefore, the linearity of the output signal and the efficiency of the present digital power amplifiers can be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power amplifier, comprising:
a plurality of amplifying stages, arranged to generate an output signal at an output terminal according to a phase-modulated signal and a plurality of amplitude-modulated signals, where each amplifying stage is arranged to receive the phase-modulated signal and one of the plurality of amplitude-modulated signals;
an inductive circuit, coupled between the output terminal and a first reference voltage;
a matching circuit, coupled between the output terminal and a loading circuit for providing a matching impedance between the output terminal and the loading circuit; and
a capacitive circuit, coupled to the output terminal for providing an adjustable capacitance to adjust a loading capacitance at the output terminal according to an adjusting signal;
wherein the adjusting signal is indicative of a power of the output signal.

2. The power amplifier of claim 1, further comprising:
a controlling circuit, arranged to generate the adjusting signal according to at least one amplitude-modulated signal of the plurality of amplitude-modulated signals.

3. The power amplifier of claim 1, further comprising:
a controlling circuit, arranged to generate the adjusting signal according to the power of the output signal.

4. The power amplifier of claim 3, wherein the controlling circuit comprises:
a detecting circuit, arranged to detect the power of the output signal for generating a detecting signal; and
a controlling unit, arranged to generate the adjusting signal according to the detecting signal.

5. The power amplifier of claim 1, further comprising:
a controlling circuit, arranged to generate the adjusting signal according to a current flowing through the inductive circuit.

6. The power amplifier of claim 5, wherein the controlling circuit comprises:
a detecting circuit, arranged to detect the current flowing through the inductive circuit for generating a detecting signal; and
a controlling unit, arranged to generate the adjusting signal according to the detecting signal.

7. The power amplifier of claim 1, wherein the capacitive circuit comprises:
a plurality of capacitors, each having a first terminal coupled to the output terminal; and
a plurality of switches, each coupled between a second terminal of one of the plurality of capacitors and a second reference voltage;
wherein the adjusting signal selectively controls the conductivities of the plurality of switches to adjust the adjustable capacitance.

8. The power amplifier of claim 1, wherein the capacitive circuit comprises:
a variable capacitor, having a first terminal coupled to the output terminal and a second terminal coupled to a second reference voltage; and
a converting circuit, arranged to convert the adjusting signal into a converted signal for controlling the variable capacitor to adjust the adjustable capacitance.

9. The power amplifier of claim 1, wherein the capacitive circuit comprises:
a plurality of variable capacitors, each having a first terminal coupled to the output terminal and a second terminal coupled to a second reference voltage; and
a plurality of converting circuits, each arranged to generate a converted signal to control one of the plurality of variable capacitors for adjusting the adjustable capacitance according to the adjusting signal.

10. The power amplifier of claim 1, wherein the phase-modulated signal and the plurality of amplitude-modulated signals are digital baseband signals.

11. The power amplifier of claim 1, wherein the adjusting signal is arranged to vary the adjustable capacitance of the capacitive circuit inversely proportional to the power of the output signal.

12. The power amplifier of claim 1, wherein the adjusting signal is arranged to vary the adjustable capacitance of the capacitive circuit to be inversely proportional to the amplitude of the output signal.

13. The power amplifier of claim 1, wherein the adjusting signal is arranged to reduce the adjustable capacitance of the capacitive circuit when the power amplifier operates under a power back-off state.

14. The power amplifier of claim 1, wherein the plurality of amplifying stages are digital amplifying circuits.

15. The power amplifier of claim 1, being a digital power amplifier.

16. A power amplifying method, comprising:
providing a plurality of amplifying stages to generate an output signal at an output terminal according to a phase-modulated signal and a plurality of amplitude-modulated signals, wherein each amplifying stage is arranged to receive the phase-modulated signal and one of the plurality of amplitude-modulated signals;
providing an inductive circuit to couple between the output terminal and a first reference voltage;
providing a matching circuit to provide a matching impedance between the output terminal and a loading circuit; and
providing a capacitive circuit having an adjustable capacitance to adjust a loading capacitance at the output terminal according to an adjusting signal;
wherein the adjusting signal is indicative of a power of the output signal.

17. The power amplifying method of claim 16, further comprising:
generating the adjusting signal according to at least one amplitude-modulated signal of the plurality of amplitude-modulated signals.

18. The power amplifying method of claim 16, further comprising:
generating the adjusting signal according to the power of the output signal.

19. The power amplifying method of claim 18, wherein the step of generating the adjusting signal according to the power of the output signal comprises:
detecting the power of the output signal to generate a detecting signal; and
generating the adjusting signal according to the detecting signal.

20. The power amplifying method of claim 16, further comprising:
generating the adjusting signal according to a current flowing through the inductive circuit.

21. The power amplifying method of claim 20, wherein the step of generating the adjusting signal according to the power of the output signal comprises:
detecting the current flowing through the inductive circuit to generate a detecting signal; and
generating the adjusting signal according to the detecting signal.

22. The power amplifying method of claim 16, wherein the phase-modulated signal and the plurality of amplitude-modulated signals are digital baseband signals.

23. The power amplifying method of claim 16, wherein the step of providing the capacitive circuit having the adjustable capacitance to adjust the loading capacitance at the output terminal according to the adjusting signal comprises:
arranging the adjusting signal to vary the adjustable capacitance of the capacitive circuit to be inversely proportional to the power of the output signal.

24. The power amplifying method of claim 16, wherein the step of providing the capacitive circuit having the adjustable capacitance to adjust the loading capacitance at the output terminal according to the adjusting signal comprises:
arranging the adjusting signal to vary the adjustable capacitance of the capacitive circuit to be inversely proportional to the amplitude of the output signal.

25. The power amplifying method of claim 16, wherein the step of providing the capacitive circuit having the adjustable capacitance to adjust the loading capacitance at the output terminal according to the adjusting signal comprises:
arranging the adjusting signal to reduce the adjustable capacitance of the capacitive circuit under a power back-off state.
